(19) United States
(12) Patent Application Publication
(10) Pub. No.: US 2014/0270541 A1
(43) Pub. Date: Sep. 18, 2014

(54) APPARATUS AND METHOD FOR PROCESSING IMAGE BASED ON FEATURE POINT

(71) Applicant: Electronics and Telecommunications Research Institute, Daejeon-si (KR)

(72) Inventors: Keun-Dong LEE, Daejeon-si (KR); Sang-Il NA, Daejeon-si (KR); Seung-Jae LEE, Daejeon-si (KR); Sung-Kwan JE, Daejeon-si (KR); Weon-Geun OH, Daejeon-si (KR); Young-Ho SUH, Daejeon-si (KR)

(73) Assignee: Electronics and Telecommunications Research Institute, Daejeon-si (KR)

(21) Appl. No.: 13/954,234

(22) Filed: Jul. 30, 2013

(30) Foreign Application Priority Data
Mar. 12, 2013 (KR) 10-2013-0026194

(51) Int. Cl. G06K 9/46; G06K 9/62

(52) U.S. Cl. CPC G06K 9/4671; G06K 9/6267
USPC 382/201

(57) ABSTRACT

An apparatus and method for processing an image based on feature points is provided, more specifically, provides a technology used in extracting feature points with high importance after determination of importance, searching images, and the like. Therefore, matching images can be effectively performed, and efficiency of time and memory can be increased.

### CROSS-REFERENCE TO RELATED APPLICATION(S)

This application claims the benefit under 35 U.S.C. §119(a) of Korean Patent Application No. 10-2013-0026194, filed on Mar. 12, 2013, in the Korean Intellectual Property Office, the entire disclosure of which is incorporated herein by reference for all purposes.

### BACKGROUND

1. Field

The following description relates to a system of processing an image based on feature points. More specifically, it is related to a technology used in recognizing an object and searching an image to effectively extract visual descriptors, measure similarities and match the visual descriptors.

2. Description of the Related Art

As the use is increased with the arrival of smart phones, an amount of distributed multimedia content has sharply grown, and an image-search technology, based on contents of the image, is further needed. Therefore, a search application using a technology based on features is also being developed.

There are representative image processing technologies based on feature points, such as Scale Invariant Feature Transform (SIFT) and Speeded-Up Robust Feature (SURF). These two technologies extract both feature points that have large variations in pixel statistics and feature descriptors, using its relevant surrounding areas in common. However, those technologies require a huge amount of computation and memory consumption in a process of extracting and matching visual descriptors. Also, because size of visual descriptors is bigger than a JPG image normalized to 640 by 480 pixels, those technologies are not suitable for a large scale search environment that is oriented to both a smart phone environment and more than 1 million images.

### SUMMARY

In one general aspect, an apparatus for processing an image based on feature points may include a feature point extraction unit to extract one or more feature points from a received image; a visual descriptor generation unit to generate one or more visual descriptors corresponding to an extracted feature points; a feature point classification unit to classify generated visual descriptors into two or more groups; and a feature point and visual descriptor selection unit to select or delete the visual descriptors in accordance with each characteristic of classified visual descriptor groups. The visual descriptor extraction unit comprises a quantization unit to determine whether to selectively quantize the generated visual descriptors and quantize determined visual descriptors.

The feature point classification unit may comprise a grouping unit to group the visual descriptors according to importance defined by a similarity level and a Nearest Neighbor Distance Ratio (NNDR).

If the visual descriptors have been quantized, the grouping unit may group the visual descriptors in accordance with each codeword, or otherwise, in accordance with either same visual descriptors or similar visual descriptors respectively.

The feature point classification unit may comprise a non-quantization classification unit to group non-quantized visual descriptors according to either same visual descriptors or similar visual descriptors respectively; and a quantization classification unit to group quantized visual descriptors according to whether the visual descriptors have been quantized into a same codeword or very likely to be quantized into a different codeword respectively.

The feature point and visual descriptor selection unit may determine whether a visual descriptor group is included in same or similar visual descriptor groups, and in response to a determination being made that the visual descriptor group is included in the same or similar visual descriptor groups, select one visual descriptor from each of the same or similar visual descriptor groups.

The feature point and visual descriptor selection unit may determine whether a visual descriptor group is included in same or similar visual descriptor groups, and in response to a determination being made that the visual descriptor group is not included in the same or similar visual descriptor groups, determine whether the visual descriptor group is included in codeword changing visual descriptor groups, and in response to a determination being made that the visual descriptor group is included in the codeword changing visual descriptor groups, delete all the visual descriptors included in the codeword changing visual descriptor groups, and in response to a determination being made that the visual descriptor group is not included in the codeword changing visual descriptor groups, select all the visual descriptors.

In another general aspect, a method for processing an image based on feature points may comprise extracting one or more feature points from a received image; generating one or more visual descriptors corresponding to an extracted feature points; classifying generated visual descriptors into two or more groups; and selecting or deleting the visual descriptors in accordance with each characteristic of classified visual descriptor groups.

The generating of visual descriptors further may comprise determining whether to selectively quantize the generated visual descriptors and quantizing determined visual descriptors.

The classifying of visual descriptors may comprise grouping the visual descriptors according to importance defined by a similarity level and a Nearest Neighbor Distance Ratio (NNDR).

If the visual descriptors have been quantized, the classifying of visual descriptors may group the visual descriptors in accordance with each codeword, or otherwise, in accordance with each of the same or similar descriptors.

The classifying of visual descriptors may comprise grouping non-quantized visual descriptors according to either same visual descriptors or similar visual descriptors respectively; and grouping quantized visual descriptors according to whether the visual descriptors have been quantized into a same codeword or very likely to be quantized into a different codeword respectively.

The selecting or deleting of the visual descriptors may comprise determining whether a visual descriptor group is included in same or similar visual descriptor groups, and in response to a determination being made that the visual descriptor group is included in the same or similar visual descriptor groups, selecting one visual descriptor from each of the same or similar visual descriptor groups.

The selecting or deleting of the visual descriptors may comprise determining whether a visual descriptor group is included in the same or similar visual descriptor groups, and in response to a determination being made that the visual descriptor group is not included in the same or similar visual descriptor groups, determining whether the visual descriptor group is included in codeword changing visual descriptor groups, and in response to a determination being made that the visual descriptor group is included in the codeword changing visual descriptor groups, deleting all the visual descriptors included in the codeword changing visual descriptor groups, and in response to a determination being made that the visual descriptor group is not included in the codeword changing visual descriptor groups, selecting all the visual descriptors.

Other features and aspects may be apparent from the following detailed description, the drawings, and the claims.

### BRIEF DESCRIPTION OF THE DRAWINGS

FIG. 1 is a diagram illustrating an example of an apparatus for processing an image based on feature points.

FIG. 2 is a diagram illustrating an example of a method for extracting feature points and a patch.

FIG. 3 is a block diagram illustrating an example of a visual descriptor generation unit.

FIG. 4 is a hierarchical quantization codebook illustrating an example of a two-level codebook.

FIG. 5 is a diagram illustrating an example of a feature point classification unit.

FIG. 6 is a diagram illustrating an example of a feature point and visual descriptor selection unit.

FIG. 7 is a diagram illustrating an example of a visual descriptor very likely to be quantized.

FIG. 8 is a diagram illustrating an example of a result of selecting a feature point by an apparatus for processing an image based on feature points.

FIG. 9 is a flowchart illustrating an example of a method for processing an image based on feature points.

FIG. 10 is a flowchart illustrating an example of a method for generating visual descriptors.

FIG. 11 is a flowchart illustrating an example of a method for classifying feature points.

FIG. 12 is a flowchart illustrating an example of a method for selecting feature points and visual descriptors.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

FIG. 1 is a diagram illustrating an example of an apparatus for processing an image based on feature points. Referring to FIG. 1, an apparatus may include a feature point extraction unit 130, a visual descriptor generation unit 140, a feature point classification unit 150, and a feature point and visual descriptor selection unit 160. The feature point extraction unit 130 may extract feature points of an inputted image, and a visual descriptor generation unit 140 may generate a visual descriptor corresponding to each of the extracted feature points. Also, the feature point classification unit 150 may classify the generated visual descriptors into groups, and the feature point and visual descriptor selection unit 160 may select and delete the feature points according to each characteristic of the classified visual descriptor groups.

In an additional aspect, the apparatus may further include an image input unit 110 to receive an image prior to the feature point extraction unit 130 and an image pre-processing unit 120 to convert the received image to black and white, then normalize the black and white image, and input the normalized image to the feature point extraction unit 130.

The feature point extraction unit 130 extracts feature points having large variations in pixel statistics, such as a corner of a subject on an image, at scale-space of the normalized black and white inputted image using a conventional technology, and calculates a scale of the feature point. Each element is specifically described hereafter with references to accompanying figures.

FIG. 2 is a diagram illustrating an example of a method for extracting feature points and a patch.

As illustrated in FIG. 2, the feature point extraction unit 130 extracts one patch with a feature point as a center. The patch size and rotation angle may be calculated to make the patch invariant to size and rotation transformation. The patch size may differ on a scale of the feature point. For example, a related art can be used such as Difference of Gaussian (DoG) detector or Fast-Hessian detector, etc.

FIG. 3 is a block diagram illustrating an example of a visual descriptor generation unit. An apparatus for processing an image based on feature points includes a quantization unit 143 to quantize visual descriptors which have been determined to be quantized after being generated by a visual descriptor extraction unit 142 included in a visual descriptor generation unit 140.

The visual descriptor generation unit 140 may generate visual descriptors based on information on an area of a patch after receiving input of the patch extracted by a feature point extraction unit 130. As illustrated in FIG. 3, firstly feature points and patches extracted by the feature point extraction unit 130 may be inputted to a feature point and patch input unit 141, and then inputted to a visual descriptor extraction unit 142 which may extract primary visual descriptors. For example, descriptors may be used, such as Scale Invariant Feature Transform (SIFT), Speeded-Up Robust Feature (SURF), Gradient Location and Orientation Histogram (GLOH) and Compressed Histogram of Gradient (CHOG), etc. Also, transformed descriptors using Principal Component Analysis (PCA) and arithmetic coding are capable of extracting the primary visual descriptors.

When the primary visual descriptors are generated, the quantization unit 143 included in the visual descriptor generation unit 140 may determine whether to quantize the visual descriptors. If the visual descriptors are not quantized, the primary visual descriptors are output as final visual descriptors. However, if the visual descriptors are quantized, then a trained quantization codebook may be inputted to the quantization unit 143. For example, k-means clustering, which is a conventional technology, may be used to generate a codebook.

The visual descriptors may be quantized by using the quantization codebook, and also Nearest Neighbor Distance Ratio (NNDR) is calculated. Here, the visual descriptors are capable of being quantized into a nearest neighbor codeword, which is nearest to the visual descriptors inputted to the quantization unit 143, among codewords included in the quantization codebook. The NNDR may be represented as Equation shown below.

$$NNDR = \frac{dist ( d , CW 1 ) + c}{dist ( d , CW 2 ) + c} \qquad ( 1 )$$

In Equation 1, ‘d’ represents an N-dimensional visual descriptor vector which is inputted to the quantization unit 143, and ‘CW1’ represents a codeword which is nearest to ‘d’, and ‘CW2’ represents a codeword which is second nearest to ‘d’, ‘c’ is a constant having a very small value to prevent a denominator from being zero. Also, a function ‘dist (d, CW)’ is for measuring a distance between a visual descriptor ‘d’ and a codeword. For example, the Euclidean distance may be used.

The visual descriptors may be grouped according to importance of similarity and NNDR.

FIG. 4 is a hierarchical quantization codebook illustrating an example of a two-level codebook. A visual descriptor generation unit 140 may output the quantized visual descriptors as final visual descriptors. If a quantization codebook consists of n-level hierarchical codebook, there may be n number of the NNDR depending on each level.

FIG. 5 is a diagram illustrating an example of a feature point classification unit. The feature point classification unit 150 receives input of visual descriptors generated by a visual descriptor generation unit 140 and feature points extracted by the feature point extraction unit 130, and determines whether visual descriptors have been quantized. After determination, the feature point classification unit 150 may include a grouping unit 155 to group visual descriptors according to importance defined by similarities and NNDR.

If the visual descriptors have been quantized by a visual descriptor generation unit 140, each visual descriptor may be grouped based on the codeword. Otherwise, same visual descriptors or similar visual descriptors may be grouped respectively.

The grouping unit 155 may include a quantization classification unit 152 and a non-quantization classification unit 153.

If the visual descriptors have not been quantized, the non-quantization classification unit 153 may group by same visual descriptors or similar visual descriptors respectively. Otherwise, if the visual descriptors are quantized, the quantization classification unit 152 may group by the visual descriptors, which have been quantized to the same codeword or are very likely to be quantized to a different codeword, respectively.

More specifically, if visual descriptors have been quantized, the visual descriptors quantized to the same codeword may be grouped into the same group. Here, if there are a plurality of the visual descriptors quantized to the same codeword, then a threshold value of a criteria for determining matching feature points, such as Nearest Neighbor Distance Ratio (NNDR), cannot be met, which may cause matching failure. Such a phenomenon may often occur when pictures including subjects of repetitive structures, such as buildings, are matched, causing decrease in matching performance. To lower the probability of such a cause, visual descriptors quantized to the same codeword are grouped, and then one of the grouped visual descriptors are selected in a following unit, that is, a feature point and visual descriptor selection unit 160, which will be described later.

Also, if the visual descriptors have been quantized, visual descriptors very likely to be quantized to a different codeword may be grouped. The visual descriptors very likely to be quantized to a different codeword are either descriptors whose NNDR is higher than the threshold value defined in advance when being quantized, or descriptors that can be quantized to a different codeword if noise is added to the visual descriptors before being quantized. Those visual descriptors are very likely to be quantized into a different codeword because of tiny noise and changes as illustrated in FIG. 7, which will be described later.

Meanwhile, if the visual descriptors have not been quantized, the same visual descriptors may be grouped. For visual descriptors extracted by Scale Invariant Feature Transform (SIFT) or Speeded Up Robust Feature (SURF), there is a low probability of existence of the same descriptors; however, in case of binarization or ternarization, there is a high probability of the existence of the same visual descriptors after dimensions of the visual descriptors are reduced by techniques of Principle Component Analysis (PCA) and Linear Discriminant Analysis (LDA), etc. In that case, matching visual descriptors may fail as determined by NNDR, so, only one visual descriptor may be selected from each group composed of the same visual descriptors in a following unit, that is, a feature point and visual descriptor selection unit 160, which will be described later.

Also, if the visual descriptors have not been quantized, similar visual descriptors may be grouped. A threshold value of the distance defined among each of the visual descriptors may be a criterion to determine similarities among each of the visual descriptors, in such as a case where the distance between visual descriptors is lower than the defined threshold value. For example, the distance among each of the visual descriptors may be obtained through the Euclidian distance or the Hamming distance. In that case, because non-quantized visual descriptors may cause a performance degradation in matching visual descriptors, here, visual descriptors are grouped composed of the visual descriptors similar to each other, and then only one visual descriptor of the similar visual descriptor group may be selected in a next unit, that is, a feature point and visual descriptor selection unit 160, which will be described later in detail.

Then, the groups classified by the quantization classification unit 152 and the non-quantization classification unit 153 respectively may output to a visual descriptor group output unit 154.

FIG. 6 is a diagram illustrating an example of a feature point and visual descriptor selection unit. The feature point and visual descriptor selection unit 160 may include the same or similar visual descriptor group determination unit 610, a representative visual descriptor selection unit 620, the codeword changing visual descriptor group determination unit 630, and a visual descriptor selection unit 640.

The feature point and visual descriptor selection unit 160 receives input of the visual descriptor groups from the feature point classification unit 150, and determines whether the inputted visual descriptor group has been grouped into the same or similar visual descriptor group by the same or similar descriptor group determination unit 610 included in the feature point and visual descriptor selection unit 160. If the inputted visual descriptor group has been grouped into the same or similar visual descriptor group, only one visual descriptor may be selected from each of the same or similar visual descriptor group and the other visual descriptors may be deleted by a representative visual descriptor selection unit 620. Otherwise, the codeword changing visual descriptor group determination unit 630 determines whether the inputted visual descriptors have been grouped to a codeword changing visual descriptor; according to which, the visual descriptors may be deleted or selected.

If the inputted visual descriptor group is included in the codeword changing visual descriptor group, the visual descriptor selection unit 640 deletes all the visual descriptors included in that group; otherwise, selects all the visual descriptors. Finally, the selected visual descriptors may be outputted.

In a process of matching those visual descriptors included in the groups of the same or similar visual descriptors or codeword changing visual descriptors, those visual descriptors are determined less important because they cause wrong matches. For example, a criterion to select one visual descriptor may be decided according to a filter response value to a feature point, a feature point scale or a distance between the center of the image and feature point, etc.

FIG. 7 is a diagram illustrating an example of a visual descriptor very likely to be quantized. The visual descriptors very likely to be quantized to a different codeword are descriptors whose NNDR is higher than the threshold value defined in advance when being quantized, or descriptors that can be quantized to a different codeword if noise is added to the visual descriptors before being quantized. Those visual descriptors are very likely to be quantized into a different codeword because of tiny noise and variations. Those visual descriptors are extracted from feature points at the same part on a picture taken of the same subject in a different angle or lighting; however those visual descriptors may be quantized to a different codeword and become a cause of a performance degradation in matching visual descriptors. Accordingly, those visual descriptors, which are higher than the defined threshold value or, if the noise is added, very likely quantized to a different codeword, are grouped into the ‘codeword changing visual descriptor group’, and then may not be selected by a feature point and visual descriptor selection unit 160. As illustrated in FIG. 7, ‘the visual descriptor which is very likely quantized into CW2’ is grouped to a codeword changing visual descriptor group, and then may not be selected by a feature point and visual descriptor selection unit 160.

FIG. 8 is a diagram illustrating an example of a result of a feature point selection by an apparatus for processing an image based on feature points. For example, Difference of Gaussian (DoG) detector and Scale-invariant feature transform (SIFT) may be used, and visual descriptors are quantized using a codebook.

Before feature points are selected, all the feature points are shown, and a size of a circle may indicate a scale of the feature point. It is determined that unnecessary points irrelevant to a subject are located in the sky and the ground shown on the image. In this case, wrong matching is very likely to happen, and also may cause a large amount of computation due to many feature points.

After final feature points are selected through visual descriptors, thereby feature points necessary for the subject are left, which may increase a matching performance.

FIG. 9 is a flowchart illustrating an example of a method for processing an image based on feature points. A method for processing an image based on feature points may include an operation 830 of extracting feature points of an inputted image, and an operation 840 of generating visual descriptors corresponding to each of the extracted feature points. In addition, the method may include an operation 850 of classifying the generated visual descriptors, and an operation 860 of selecting and deleting the feature points according to each characteristic of the classified visual descriptor groups.

In an additional aspect, prior to the operation 830, the method may further include an operation 810 of receiving an image, and an operation 820 of pre-processing an image to convert the received image to black and white, then normalize the black and white image, and input the normalized image to the operation 830.

Points are extracted, as feature points, that have large variations in pixel statistics, such as a corner of a subject on an image, at scale-space of the normalized black and white inputted image using conventional technology, and a scale of the feature points is also calculated in 830.

Here, the operation 830 of extracting feature points and a patch may be omitted in reference to FIG. 2 as mentioned above.

FIG. 10 is a flowchart illustrating an example of a method for generating visual descriptors. The method may further include an operation 847 of quantizing visual descriptors generated in an operation 840.

At first, the patch extracted in the operation 830 is inputted to the operation 840, and visual descriptors based on the patch are generated in 840. More specifically, the feature points and patch which are both extracted in the operation 830 are inputted in 841, and primary visual descriptors are extracted in 842. For example, Scale Invariant Feature Transform (SIFT), Speeded-up Robust Feature (SURF), Gradient Location and Orientation Histogram (GLOH), Compressed Histogram of Gradients (CHOG), etc., may be used, and also transformed descriptors using Principal Component Analysis (PCA) and arithmetic coding may be used to extract the primary visual descriptors.

After the primary visual descriptors are extracted in 842, the determination to quantize visual descriptors may be made in 847. If the visual descriptors are not quantized, the primary visual descriptors are outputted as final visual descriptors in 846. However, if the visual descriptors are quantized, then a trained quantization codebook 844 may be inputted to an operation 845 of quantizing the visual descriptors and calculating NNDR. For example, k-means clustering, which is a related art, etc., may be used to generate a codebook.

The visual descriptors may be quantized by using the quantization codebook 844, and also NNDR is calculated in 845. Here, the visual descriptors are capable of being quantized into the nearest neighbor codeword, which has visual descriptors nearest to the inputted visual descriptors, among codewords included in the quantization codebook 844. The NNDR may be represented as Equation 1 as mentioned previously.

In Equation 1, ‘d’ represents a N-dimensional visual descriptor vector which is inputted to the operation 847, and ‘CW1’ represents a codeword which is nearest to ‘d’, and ‘CW2’ represents a codeword which is second nearest to ‘d’, ‘c’ is a constant having a very small value to prevent a denominator from being zero. Also, a function ‘dist (d, CW)’ is to measure the distance between a visual descriptor ‘d’ and a codeword. For example, the Euclidean distance maybe used.

The visual descriptors may be grouped according to importance of similarity and NNDR.

A description for a hierarchical quantization codebook may be omitted in reference to FIG. 4 as mentioned above.

FIG. 11 is a flowchart illustrating an example of a method for classifying feature points. Firstly, in an operation 850 of classifying feature points, both visual descriptors generated in the operation 840 and feature points extracted in operation 830 are received in 851, and whether the visual descriptors have been quantized is determined in 852. In addition, visual descriptors may be grouped according to importance defined by similarity and NNDR in 900.

In operation 900, if the visual descriptors have been quantized, each visual descriptor may be grouped depending on the codewords. Otherwise, same visual descriptors or similar visual descriptors may be grouped respectively.

The operation 900 may include an operation 858 of classifying the quantized visual descriptors and an operation 859 of classifying the non-quantized visual descriptors.

If the visual descriptors are quantized, the visual descriptors, which have been quantized to the same codeword or likely to be quantized into a different codeword, may be grouped respectively in 858. Otherwise, if the visual descriptors have not been quantized, same visual descriptors or similar visual descriptors may be grouped respectively in 859.

More specifically, if visual descriptors have been quantized, the visual descriptors quantized to the same codeword may be grouped into the same group in 853. Here, if there are a plurality of the visual descriptors quantized to the same codeword, then a threshold value of a criteria for determining matching feature points, such as Nearest Neighbor Distance Ratio (NNDR) cannot be met, which may cause matching failure. Such a phenomenon may often occur when pictures including subjects of repetitive structures such as buildings are matched, causing decrease in a matching performance. To lower the probability of such a cause, visual descriptors quantized to the same codeword are grouped, and then one of the grouped visual descriptors are selected in a following operation 860 of selecting feature points and visual descriptors, which will be described later.

Also, if the visual descriptors have been quantized, visual descriptors very likely to be quantized to a different codeword may be grouped in 854. The visual descriptors very likely to be quantized to a different codeword are either descriptors whose NNDR is higher than the threshold value defined in advance when being quantized, or descriptors that can be quantized to a different codeword if noise is added to the visual descriptors before being quantized. Those visual descriptors are very likely to be quantized into a different codeword because of tiny noise and changes as illustrated above in FIG. 7. Those visual descriptors are extracted from feature points at the same part on a picture taken of the same subject in a different angle or lighting; however those visual descriptors may be quantized to a different codeword and become a cause of a performance degradation in matching visual descriptors. Accordingly, those visual descriptors, which are either higher than the defined threshold value or very likely quantized to a different codeword if the noise is added, are grouped into the ‘codeword changing visual descriptor group’, and then may not be selected in an operation 860 of selecting feature points and visual descriptor following the operation 850 of classifying feature points, which will be described in FIG. 12.

Meanwhile, if the visual descriptors have not been quantized, the same visual descriptors may be grouped in 855. For visual descriptors extracted by Scale Invariant Feature Transform (SIFT) or Speeded Up Robust Feature (SURF), there is a low probability of existence of the same descriptors; however, in case of binarization or ternarization, there is a high probability of the existence of the same visual descriptors after dimensions of the visual descriptors are reduced by techniques of Principle Component Analysis (PCA) and Linear Discriminant Analysis (LDA), etc. In that case, matching visual descriptors may be failed as determined by NNDR, so, only one visual descriptor may be selected among each group composed of the same visual descriptors in a following operation 860 of selecting feature points and visual descriptors, which will be described later in FIG. 12.

Also, if the visual descriptors have not been quantized, similar visual descriptor may be grouped in 856. A threshold value of the distance defined among each of the visual descriptors may be a criterion to determine similarities among each of the visual descriptors, in such a case where the distance between visual descriptors is lower than the defined threshold value. For example, the distance among each of the visual descriptors may be obtained through the Euclidian distance or the Hamming distance. In that case, because non-quantized visual descriptors may cause a performance degradation in matching visual descriptors, here, visual descriptors are grouped composed of the visual descriptors similar to each other, and then only one visual descriptor of the similar visual descriptor group may be selected in a next operation 860 of selecting feature points and visual descriptors, which will be described later in detail in FIG. 12.

FIG. 12 is a flowchart illustrating an example of a method for selecting feature points and visual descriptors. An operation 860 of selecting feature points and visual descriptors may include an operation 861 of receiving input of visual descriptor groups from the operation 850; an operation 862 of determining if the visual descriptor group is included in same or similar visual descriptor group; and if yes, an operation 863 of selecting one visual descriptor respectively from the same or similar visual descriptor groups or deleting the others. That is because those visual descriptors included in the same or similar visual descriptor groups or code word changing visual descriptor groups may cause wrong matching. So, those visual descriptors may be determined less important than other visual descriptors. For example, a criterion to select one visual descriptor may be decided according to a filter response value to a feature point, a feature point scale, or the distance between the center of the image and feature point, etc.

If the inputted visual descriptor groups are not included in the same or similar visual descriptor groups, all the visual descriptors are deleted in 865 or selected in 866 depending on whether the visual descriptor groups are included in the codeword changing visual descriptor groups.

More specifically, if included in codeword changing visual descriptor groups, all the visual descriptors are deleted in 865; otherwise, all the visual descriptors are selected in 866. Finally, selected visual descriptors are outputted in 867.

A result of a method for processing an image based on feature points is the same as described above with reference to FIG. 8, which may be omitted here.

Instead of extracting all the visual descriptors of all the feature points, the visual descriptors can be selectively saved depending on importance of the feature points, so efficiency of time and memory in execution may be increased.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level codes that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing an image based on feature points, the apparatus comprising:
a feature point extraction unit configured to extract one or more feature points from a received image;
a visual descriptor generation unit configured to generate one or more visual descriptors corresponding to an extracted feature points;
a feature point classification unit configured to classify generated visual descriptors into two or more groups; and
a feature point and visual descriptor selection unit configured to select or delete the visual descriptors in accordance with each characteristic of classified visual descriptor groups.

2. The apparatus of claim 1, wherein the visual descriptor extraction unit comprises a quantization unit configured to determine whether to selectively quantize the generated visual descriptors and quantize determined visual descriptors.

3. The apparatus of claim 1, wherein the feature point classification unit comprises a grouping unit configured to group the visual descriptors according to importance defined by a similarity level and a Nearest Neighbor Distance Ratio (NNDR).

4. The apparatus of claim 3, wherein if the visual descriptors have been quantized, the grouping unit groups the visual descriptors in accordance with each codeword, or otherwise, in accordance with either same visual descriptors or similar visual descriptors respectively.

5. The apparatus of claim 1, wherein the feature point classification unit comprising:
a non-quantization classification unit configured to group non-quantized visual descriptors according to either same visual descriptors or similar visual descriptors respectively; and
a quantization classification unit configured to group quantized visual descriptors according to whether the visual descriptors have been quantized into a same codeword or very likely to be quantized into a different codeword respectively.

6. The apparatus of claim 1, wherein the feature point and visual descriptor selection unit determines whether a visual descriptor group is included in same or similar visual descriptor groups, and in response to a determination being made that the visual descriptor group is included in the same or similar visual descriptor groups, selects one visual descriptor from each of the same or similar visual descriptor groups.

7. The apparatus of claim 1, wherein the feature point and visual descriptor selection unit determines whether a visual descriptor group is included in same or similar visual descriptor groups, and in response to a determination being made that the visual descriptor group is not included in the same or similar visual descriptor groups, determines whether the visual descriptor group is included in codeword changing visual descriptor groups, and in response to a determination being made that the visual descriptor group is included in the codeword changing visual descriptor groups, deletes all the visual descriptors included in the codeword changing visual descriptor groups, and in response to a determination being made that the visual descriptor group is not included in the codeword changing visual descriptor groups, selects all the visual descriptors.

8. A method for processing an image based on feature points, the method comprising:
extracting one or more feature points from a received image;
generating one or more visual descriptors corresponding to an extracted feature points;
classifying generated visual descriptors into two or more groups; and
selecting or deleting the visual descriptors in accordance with each characteristic of classified visual descriptor groups.

9. The method of claim 8, wherein the generating of visual descriptors further comprises determining whether to selectively quantize the generated visual descriptors and quantizing determined visual descriptors.

10. The method of claim 8, wherein the classifying of visual descriptors comprises grouping the visual descriptors according to importance defined by a similarity level and a Nearest Neighbor Distance Ratio (NNDR).

11. The method of claim 10, wherein if the visual descriptors have been quantized, the classifying of visual descriptors groups the visual descriptors in accordance with each codeword, or otherwise, in accordance with each of the same or similar descriptors.

12. The method of claim 8, wherein the classifying of visual descriptors comprises:
grouping non-quantized visual descriptors according to either same visual descriptors or similar visual descriptors respectively; and
grouping quantized visual descriptors according to whether the visual descriptors have been quantized into a same codeword or very likely to be quantized into a different codeword respectively.

13. The method of claim 8, wherein the selecting or deleting of the visual descriptors comprises determining whether a visual descriptor group is included in same or similar visual descriptor groups, and in response to a determination being made that the visual descriptor group is included in the same or similar visual descriptor groups, selecting one visual descriptor from each of the same or similar visual descriptor groups.

14. The method of claim 8, wherein the selecting or deleting of the visual descriptors comprises determining whether a visual descriptor group is included in the same or similar visual descriptor groups, and in response to a determination being made that the visual descriptor group is not included in the same or similar visual descriptor groups, determining whether the visual descriptor group is included in codeword changing visual descriptor groups, and in response to a determination being made that the visual descriptor group is included in the codeword changing visual descriptor groups, deleting all the visual descriptors included in the codeword changing visual descriptor groups, and in response to a determination being made that the visual descriptor group is not included in the codeword changing visual descriptor groups, selecting all the visual descriptors.
